(19) United States
(12) Patent Application Publication
(10) Pub. No.: US 2021/0317780 A1
(43) Pub. Date: Oct. 14, 2021

(54) ZHOU ENGINE AND POWER-CAM MECHANISM

(71) Applicants: Jing Yuan ZHOU, Richmond (CA); Jihua ZHOU, Richmond (CA)

(72) Inventors: Jing Yuan ZHOU, Richmond (CA); Jihua ZHOU, Richmond (CA)

(21) Appl. No.: 15/118,484

(22) PCT Filed: Feb. 14, 2014
(86) PCT No.: PCT/CA2014/050106

§ 371 Date: Aug. 12, 2016

(51) Int. Cl. F02B 75/22; F02B 75/24; F02B 75/02; F01B 1/06; F01B 9/06; F16C 29/04; F16C 33/30; F23R 3/28

(52) U.S. Cl. CPC F02B 75/222; F02B 75/24; F02B 75/02; F01B 1/0668; F02B 2075/028; F16C 29/04; F16C 33/306; F23R 3/286; F01B 9/06

(57) ABSTRACT

An internal combustion engine featuring a radial array of cylinders and pistons; the pistons having rods including cam followers engaging the surface of a cam drive to transfer reciprocating linear motion into rotary motion; wherein between the piston rods and the engine housing are disposed arrays of toothed rollers to provide a rolling interface.

This invention includes Zhou Engine and power-cam mechanism.

### Zhou Engine

Zhou Engine is an engine which works as an internal-combustion engine and a combustion chamber of a gas turbine.

The primary purpose of inventing Zhou Engine is to increase thermal efficiency. This will reduce carbon emission and pollution, both are major issues in the current world. Also, raising the power density of power equipment would be reached.

A four-stroke diesel engine has the highest thermal efficiency of all current internal-combustion engines. The working process has intake stroke, compression stroke, expansion stroke (or power stroke) and exhaust stroke. The piston is driven by the crank-link mechanism. The piston-top motion curve (1H, in FIG. 2) is similar to a cosine curve. The defects include short burning duration, inadequate expansion, and sliding friction caused by the crank-link mechanism. These defects decrease thermal efficiency, produce noise, and so on. These defects will be overcome by Zhou Engine.

Zhou Engine is partially similar to a conventional four-stroke engine in working principle. Zhou Engine also has intake stroke (1O), compression stroke (1P), expansion stroke (1R), and exhaust stroke (1S). And the valves action, fuel injection and spark ignition are the same as in four-stroke engine. The piston (3E, 9D) of Zhou Engine is in reciprocating motion in the cylinder (3D, 9L). But, Zhou Engine has the following exclusive characteristics:

1. A Zhou Engine comprises: shells (3C, 9B), many cylinders (3D, 9L), many pistons (3E, 9D), many toothed-roller arrays (3F, 9E, 9F), one power-cam (3B, 9C), a set of cylinder heads and valve timing mechanism and fuel supply system and ignition system.

2. Its piston-top motion curve (1H, in FIG. 1), that its piston's (3E, 9D) motion follows, can be divided into any number of segments, each of which can be discretionary adjusted and optimized in design to meet our wants (reference in FIG. 16).

3. Its work cycle (1T, in FIG. 1) completes five separate processes (reference FIG. 1 and comparison with FIG. 2)—intake stroke (1O), compression stroke (1P), combustion period (1Q), expansion stroke (1R), and exhaust stroke (1S)—during one revolution or less of its power-cam (3B, 9C), and one single thermodynamic cycle (reference in FIG. 14):
(a) The each process can have different duration; the each stroke can have different length.
(b) Intake stroke (1O): The function of its intake stroke (1O) is the same as that in four-stroke engine. Its intake valves keep open and its exhaust valves keep shut. The intake stroke segment of the piston-top motion curve (1H, in FIG. 1), can be carefully adjusted, to make airflow smoother and draw more air into the cylinder (3D, 9L).
(c) Compression stroke (1P): The function of its compression stroke (1P) is the same as that in four-stroke engine. Its intake valves and exhaust valves keep shut. But, its compression stroke (1P) takes less time, to decrease heat loss in this stroke and reserve more time for other processes.
(d) Combustion period (1Q): Four-stroke engines have some issues in combustion process—including preignition, detonation, and later combustion—which arise from the period of combustion being too short. Zhou Engine has “combustion period” (1Q), which is reserved period for combustion to improve the combustion process. Its intake valves and exhaust valves keep shut. The fuel injection starts at the beginning of the combustion period, then spark ignite if needed, and then the best combustion state keeps within the combustion period (1Q). Its combustion state may be constant volume combustion, isothermal combustion, or other better combustion states—as our design, by the fuel injecting as burning as its piston movement, which follows the piston-top motion curve (1H, in FIG. 1). We can keep the combustion process on a sustainable high-pressure boundary or on a sustainable high temperature boundary to get as great as possible thermal efficiency. Thus, we can avoid the combustion issues of four-stroke engine, and get higher efficiency. We can also use various fuels in Zhou Engine, which include gasoline, kerosene, diesel, natural gas, carbon monoxide, alcohol, hydrogen and so on. Further, we can have insulating ceramics surround the burning substance to reduce heat loss.
(e) Expansion stroke (1R): The function of its expansion stroke (1R) is a little difference with that in four-stroke engine. There is no combustion and only expansion to output power. The expansion stroke also has extra expansion (1M). Its intake valves and exhaust valves keep shut. Further, we can adjust the expansion stroke segment (1R) of the piston-top motion curve (1H, in FIG. 1), to have the high temperature take less time, to decrease heat loss. These results that Zhou Engine output more work and get higher thermal efficiency.
(f) Exhaust stroke (1S): The function of its exhaust stroke (1S) is the same as that in four-stroke engine. Its intake valves keep shut and its exhaust valves keep open. The exhaust stroke (1S) segment of piston-top motion curve (1H, in FIG. 1), can be carefully adjusted, to have smoother gas flow and reduce residual exhaust. This is good for reducing noise and increasing efficiency.
(g) To have more optimization of Zhou Engine by further more carefully adjusting the piston-top motion curve (1H, in FIG. 1) is possible.

4. To perform item 2 and 3 above, two examples of Zhou Engine are shown in drawings, example A (reference FIGS. 3 to 8) and example B (reference FIGS. 9 to 13). The working principles are in the following:
(a) Each piston (3E, 9D) moves inside one cylinder (3D, 9L), and each cylinder contains only one piston.
(b) The cylinders (3D, 9L) may be set in pairs, and then each pair of cylinders is at the same axial line. Then, the pistons (3E, 9D) may work as pairs, and each pair of pistons is at the same axial line and precise inverse motion. This is easy to have the whole Zhou Engine in dynamic balance and to eliminate vibration.
(c) Each piston (3E, 9D) is in reciprocating motion, and is confined by a cylinder (3D, 9L) and toothed-roller arrays (3F, 9E, 9F). A toothed-roller array (3F in FIG. 8; 9E, 9F in FIG. 13) is that a cage (3L, 13B, 13C) restricts and synchronizes many toothed-rollers (3I, 13A). Each toothed-roller (3I, 13A) comprises 1 bearing surface (8A, 13E) and many teeth (8B, 13D). A toothed-track (3R, 3Q, 9U, 9V) comprises 1 bearing surface (3M, 3J, 10B, 12C) and many teeth (3N, 3K, 10E, 12D) in a row. A toothed-roller array (3F, 9E, 9F), or rather synchronized toothed-rollers, roll between a toothed-track of a piston (3Q, 9V) and a toothed-track of a shell (3R, 9U), withstand the normal force with their bearing surface (8A, 3J, 3M, 13E, 12C, 10B) contacting, and mesh their teeth (8B, 3K, 3N, 13D, 12D, 10E, reference Detail A of FIG. 3). Thus, the synchronized toothed-rollers (3I, 13A) are always at the proper position, proper motion state, no sliding, and bearing the piston's lateral force coming from the power-cam (3B, 9C) on the bearing surface (8A, 13E).
(d) The one power-cam (3B, 9C) drives the many pistons (3E, 9D) by the wheels (6A, 6B, 9H, 12A) mounted on the pistons and the tracks (4C, 11B) of the power-cam, and vice versa. We design and manufacture the tracks of power-cam (4C, 11B) according to the piston-top motion curve (1H, in FIG. 1).
(e) A conventional four-stroke engine uses crank-link mechanism to drive pistons, which has many parts in sliding frictions, especially there is large normal pressure between piston and cylinder. These sliding frictions waste work, and reduce thermal efficiency. A Zhou Engine has no crank-link mechanism. A Zhou Engine has much fewer sliding friction, only in there—between piston and cylinder for gas sealing, between toothed-rollers (3I, 13A) and their cages (3L, 13B, 13C), and between the meshing teeth—the normal pressure on which are little. But, the lateral force of the piston that comes from the power-cam, is withstood by the rolling toothed-rollers (3I, 13A) on the toothed-tracks (3R, 3Q, 9U, 9V), and does not produce sliding friction. This further increases the thermal efficiency of the Zhou Engine.
(f) Zhou Engine has much smaller normal pressure between pistons and cylinders than a conventional four-stroke engine, as mentioned above. Thus, we can have the pistons move much faster, and then get much faster rated speed and get much higher power density.

5. In the drawings of FIGS. 14 to 16, Example C shows an appliance which is Zhou Engine working together with a multistage dynamic compressor and a turbine, or rather, a Zhou Engine works as a combustion chamber of a gas turbine. The characteristics are in following:
(a) FIG. 14 is the pV-diagram of a Zhou Engine.
Comparison with gas turbine in pV-diagram, the Zhou Engine is a piston engine. A piston engine has higher compression ratio, higher combustion temperature and higher pressure, to able to get higher thermal efficiency.
Comparison with four-stroke diesel engine in pV-diagram, the Zhou Engine has constant volume combustion (14B) and extra expansion (1M). These may produce more work and get higher thermal efficiency.
This pV-diagram (FIG. 14) also fits the appliance (in FIG. 15) which is the Zhou Engine (15G) working together with the multistage dynamic compressor (15B) and the turbine (15C). We can choose some joint points (14E, 14F, 14H) on this pV-diagram, and then design the appliance (reference FIGS. 15 and 16).
(b) On the Zhou Engine (15G), we can precisely adjust the intake stroke (1O) segment of the piston-top motion curve (1H, in FIG. 16), to remove pulsation in the whole intake flow, to fit the multistage dynamic compressor (15B, in FIG. 15). We can also precisely adjust the exhaust stroke (1S) segment of the piston-top motion curve (1H, in FIG. 16), to remove pulsation in the whole exhaust flow, to fit the turbine (15C, in FIG. 15). We can create exact functions to describe each segment of the piston-top motion curve (1H).
(c) Zhou Engine can work as a combustion chamber of a gas turbine, and shows in FIG. 15. This gas turbine may have two power output shaft, one shaft on the turbine (15D) and one shaft on the Zhou Engine (15F).
(d) The appliance (in FIG. 15) which is Zhou Engine (15G) working together with multistage dynamic compressor (15B) and turbine (15C), can achieve higher thermal efficiency and greater volume power density (detail in FIG. 16).

6. Comparison with four-stroke diesel engine, Zhou Engine has those advantages—the smoother airflow, the better combustion state, the less heat loss, the extra expansion, the less residual exhaust, the much fewer sliding friction—which are mentioned above. Supposing the effective efficiency of a four-stroke diesel engine is 40%, we estimate the effective efficiency of Zhou Engine would be 60%.

### Power-Cam Mechanism

Power-cam mechanism is an improved cam mechanism.

Cam mechanism is a widely used in all mechanical fields. The cam is a rotating or sliding piece in a mechanical linkage, used especially in transforming rotary motion into linear motion or vice-versa. Because of its sliding frictions, its efficiency is low, and it is only suitable for motion transforming rather than driving force transforming.

This power-cam mechanism uses rolling motions as much as possible instead of sliding to reduce friction, especially between the follower (18C) and the casing (18D). It is suitable for driving force transforming as well as motion transforming.

The drawings of FIG. 17 to 22 are on power-cam mechanism.

Power-cam mechanism (18A, in FIG. 18) comprises: power-cam (3B), follower (18C), casing (18D), and toothed-roller arrays (18E).

The power-cam (3B), which rotates round axle center (18H), drives the follower (18C) in reciprocation motion (18K) along a straight line or an arc, and vice versa. The casing (18D) and the axle center (18H) are stationary. A toothed-roller array (18E) is that many toothed-rollers (20F, 21F) are restricted and synchronized. A toothed-track (18I, 18J) has one bearing surface (20B, 20D, 21B, 21D), and has many teeth (20A, 20C, 21A, 21C). A toothed-roller (20F, 21F) is a roller with many teeth. Or rather, a toothed-roller (20F, 21F) has one bearing surface (20H, 21H) and many teeth (20G, 21G). The bearing surface (20H, 21H) is for rolling on the bearing surface of a toothed-track (20B, 20D, 21B, 21D). And the teeth (20G, 21G) are for meshing with the teeth of toothed-track (20A, 20C, 21A, 21C). While they are working, the toothed-roller array (18E), or rather the synchronized toothed-rollers (20F, 21F), roll (reference Detail F1) between the toothed-track of the follower (18I) and the toothed-track of the casing (18J), withstand the normal force on their bearing surface (20H, 20B, 20D, 21H, 21B, 21D) contacting, and mesh (20I, 20J, 21I, 21J) their teeth (20G, 20A, 20C, 21G, 21A, 21C), to keep the toothed-rollers always in the proper position and avoid sliding.

The tracks of the power-cam (18G) may be very complicated, that means the relationship between the follower (18C) motion and time is very complicated.

The tracks of the power-cam (18G) may have teeth (19K) if needed. If so, the wheels of the follower (19A, 19F) must have teeth (19C, 19H) corresponding to, to keep the wheels always rolling and avoid sliding, to prevent energy loss from the wheels sliding while speed changing. The wheels (19A, 19F) change speed periodically. The roller bearings of the wheels (19D, 19L) may be toothed roller bearings or preloaded roller bearings, to prevent their rollers from sliding while speed changing.

The toothed roller bearing mentioned above may comprise: an outer ring with toothed-track, an inner ring with toothed-track, many toothed-rollers, and a cage to restrict and synchronize the toothed-rollers. Its principle is similar to the co-working of toothed-tracks (18I, 18J) and synchronized toothed-rollers (20F, 21F).

All the teeth mentioned above, may be of involute profile.

Thus, power-cam mechanism (18A) has very few sliding frictions, which includes: between toothed-rollers (20F) and their cage (20E), and between meshing teeth. And the other frictions are all rolling ones. So it (18A) has much higher mechanical transforming efficiency than conventional cam mechanism and most crank-link mechanism. It is also able to transform very complicated follower (18C) motion. It can be used in all mechanical fields.

Zhou Engine mentioned above, has used power-cam mechanism (18A), showing in following:

In example A, reference FIG. 3 and FIG. 18. The power-cam (3B) in FIG. 3 corresponds to the power-cam (3B) in FIG. 18. The piston (3E) corresponds to the follower (18C). The shell (3C) corresponds to the casing (18D). The toothed-roller array (3F) in FIG. 3 corresponds to the toothed-roller array (18E) in FIG. 18.

In example B, reference FIG. 9 and FIG. 18. The power-cam (9C) in FIG. 9 corresponds to the power-cam (3B) in FIG. 18. The piston (9D) corresponds to the follower (18C). The shell (9B) corresponds to the casing (18D). The toothed-roller array A (9E) and the toothed-roller array B (9F) correspond to the toothed-roller array (18E).

### DESCRIPTION OF THE DRAWINGS

The drawings in FIGS. 1 to 16 are on Zhou Engine, in which show three examples—Example A, Example B and Example C. Example A and Example B are 2 examples of Zhou Engine. Example C is a Zhou Engine, co-working with a multistage dynamic compressor and a turbine, or rather, working as a combustion chamber of a gas turbine.

The drawings in FIG. 17 to 22 are on power-cam mechanism.

The drawing in FIG. 23 is an appendix of the abstract.

FIG. 1: The piston-top motion curve (1H) of Zhou Engine. This is a schematic diagram and further optimization can be done. The meanings of the symbols are in the following table (Table 1).

TABLE 1

| Symbols | Meanings |
|---|---|
| 1A | intake valve open |
| 1AX | Time, use “t” to represent in |
| | expressions |
| 1AY | Piston-top position, that is distance |
| | between piston-top and cylinder |
| | head |
| 1B | fuel injection |
| 1C | spark ignition if needed |
| 1D | Cylinder head position |
| 1E | exhaust valve open |
| 1H | piston-top motion curve |
| 1I | compression volume, that is the |
| | working volume at the end of |
| | compression stroke |
| 1J | small gap for piston motion |
| | allowance and valves motion |
| 1K | this working volume is clearance |
| | volume, it tends to zero |
| 1L | intake volume, that is the working |
| | volume at the end of intake stroke |
| 1M | extra expansion |
| 1N | expansion volume, that is the |
| | working volume at the end of |
| | expansion stroke |
| 1O | intake stroke |
| 1P | compression stroke |
| 1Q | combustion period |
| 1R | expansion stroke |
| 1S | exhaust stroke |
| 1T | work cycle, use “C” to represent |
| | cycle time in expressions |

$$compression ratio = \frac{intake volume ( 1 L )}{compression volume ( 1 I )}$$

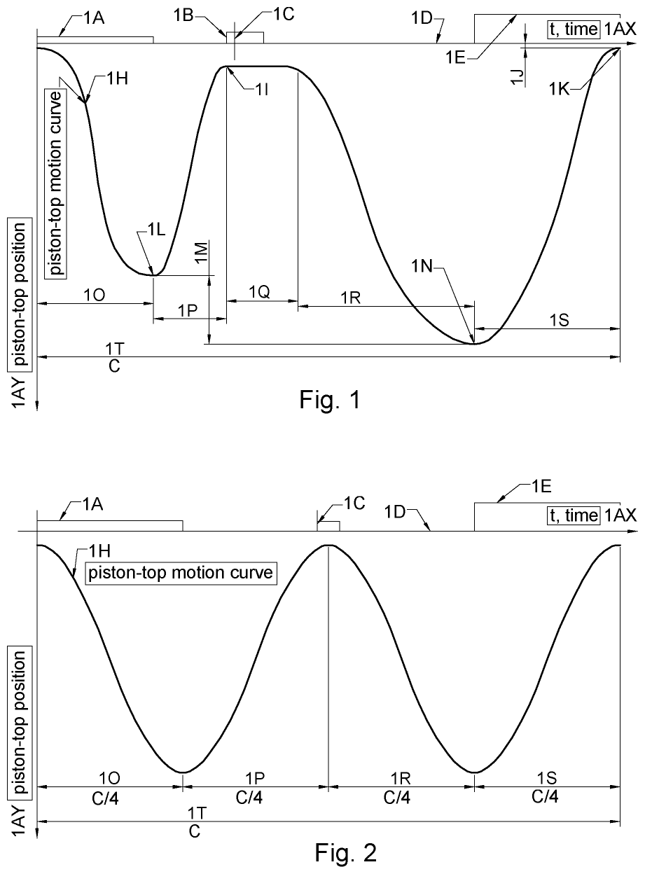

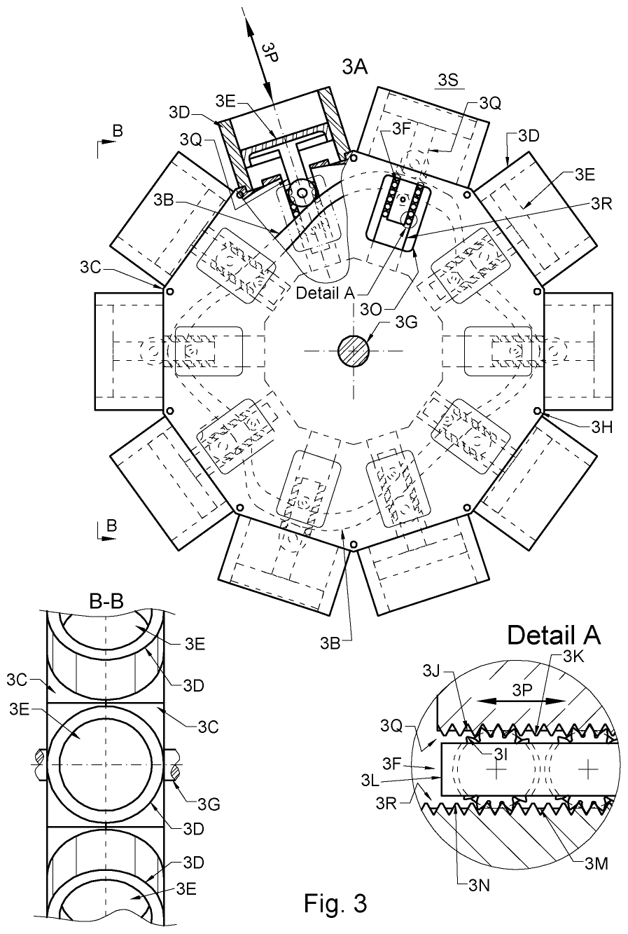

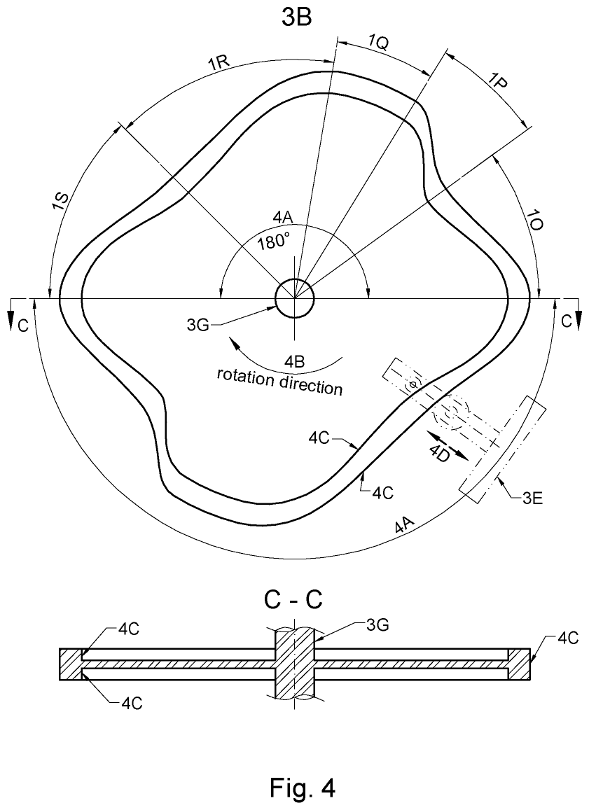

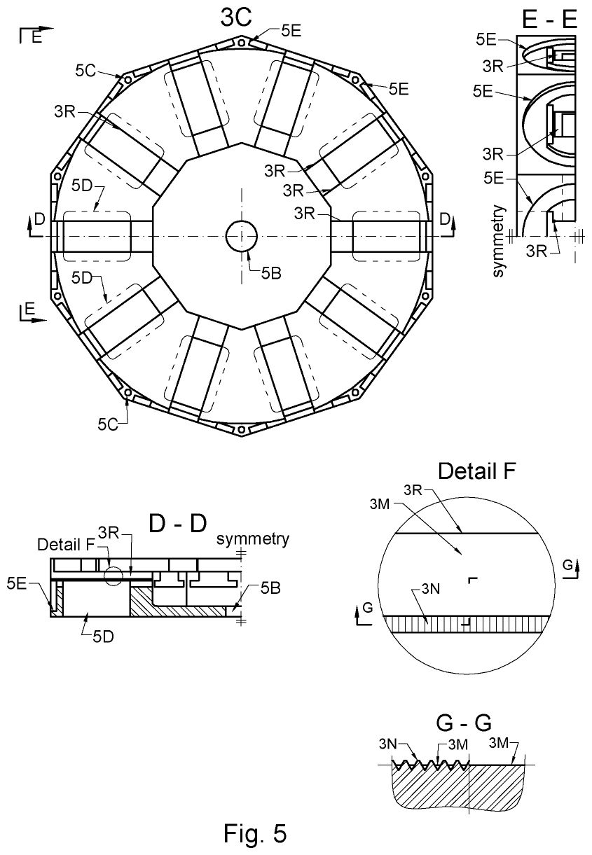

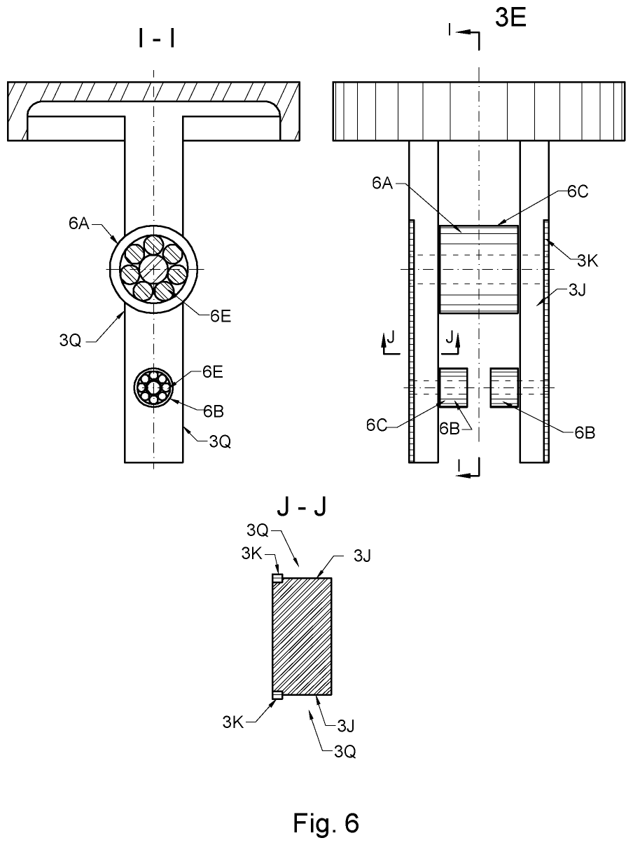

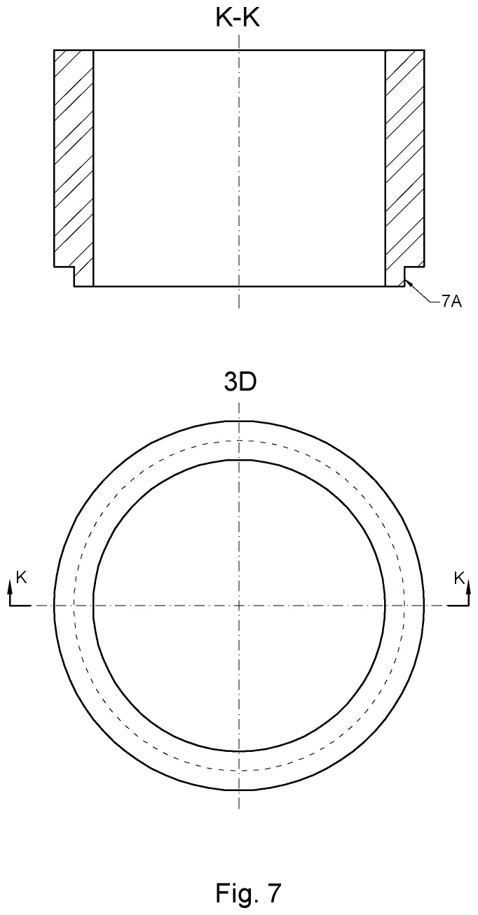

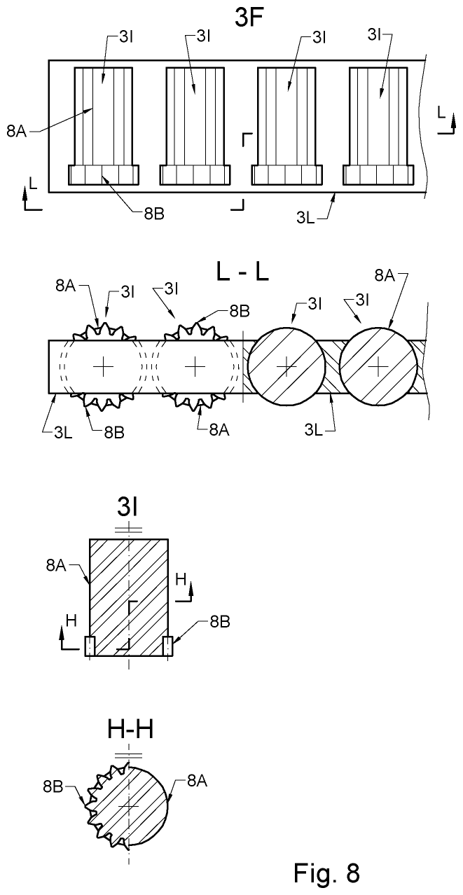

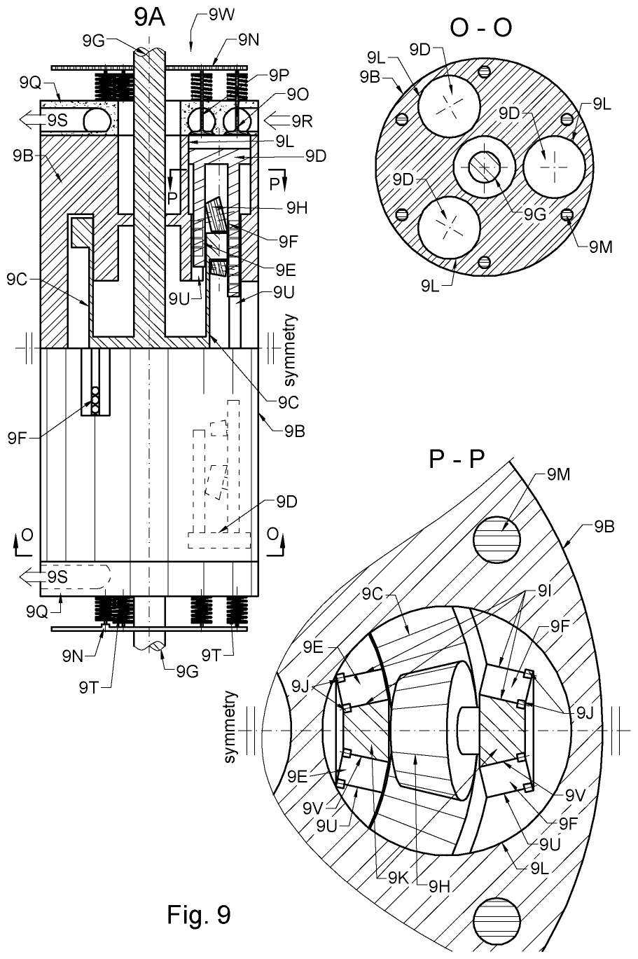

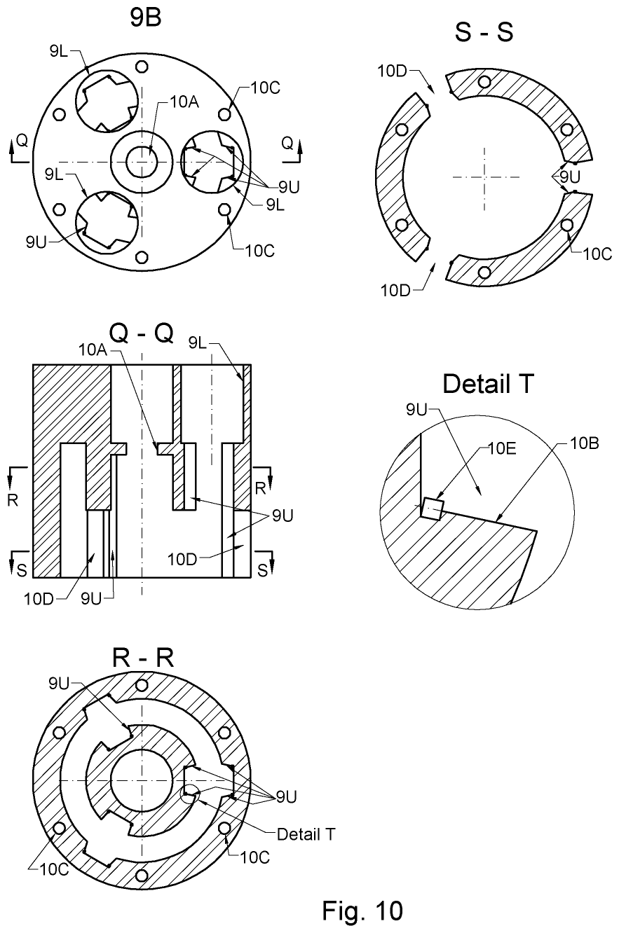

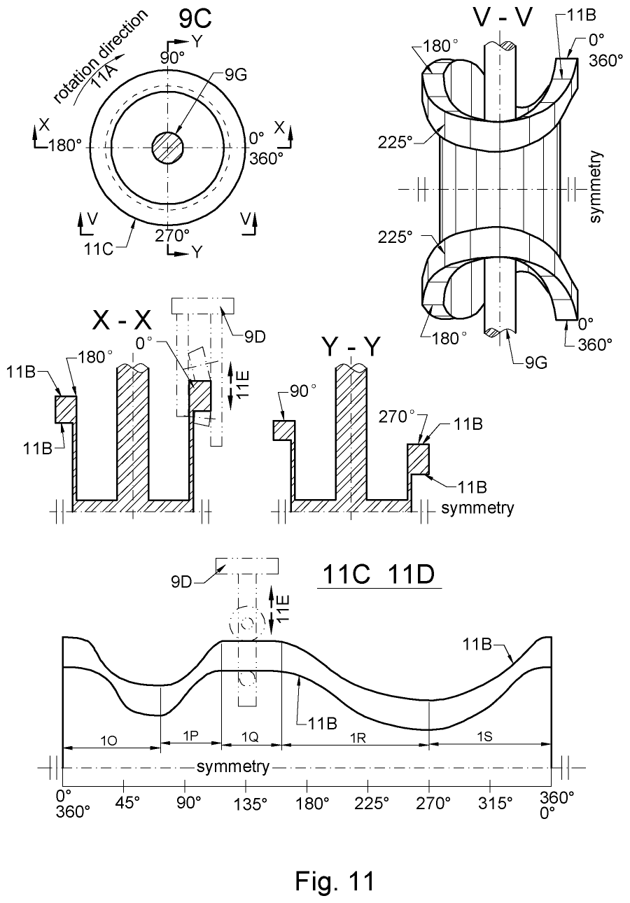

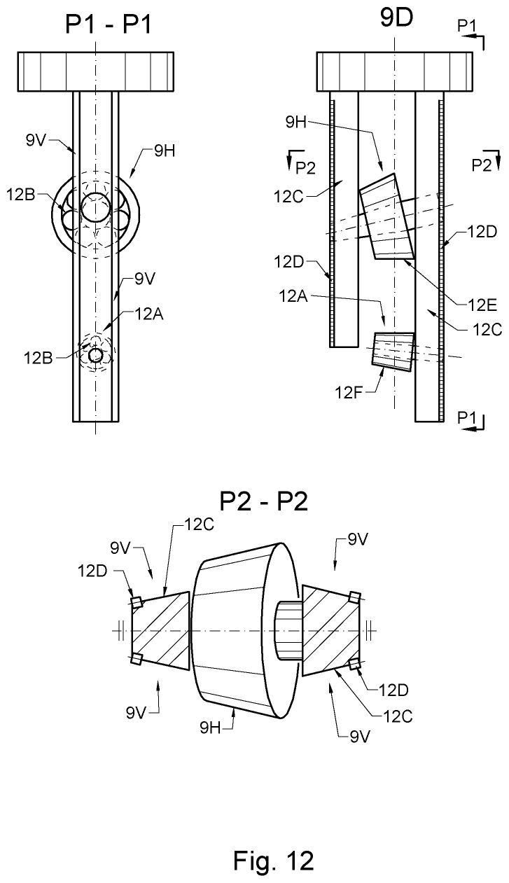

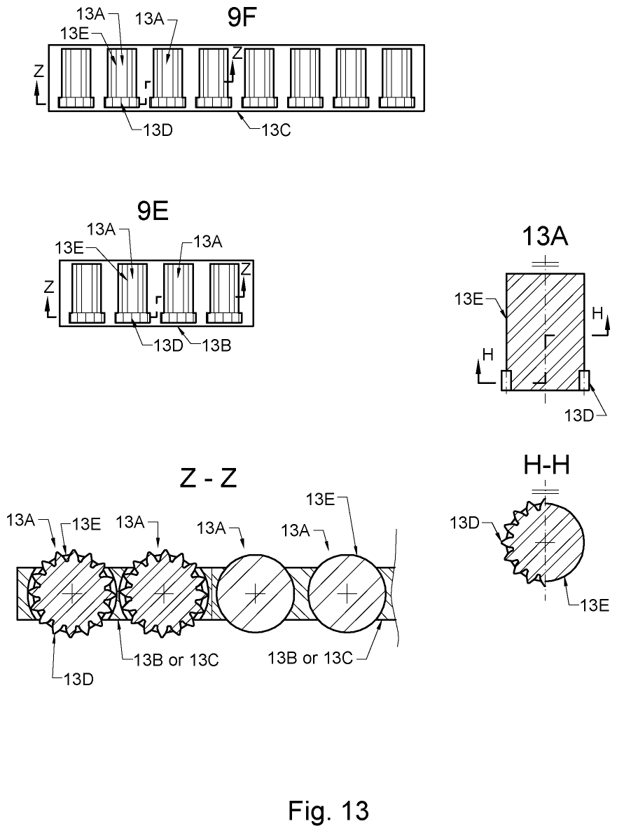

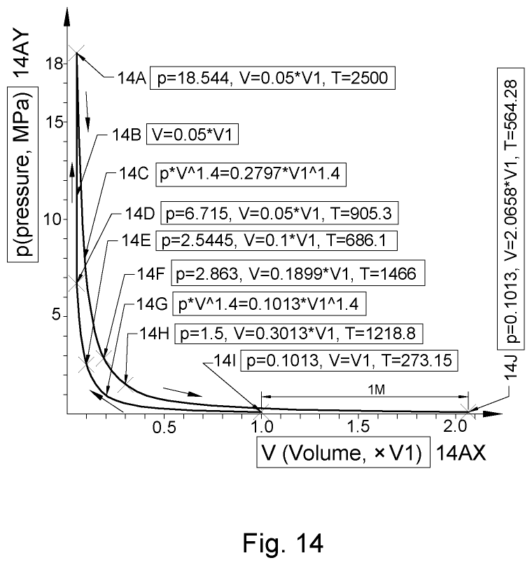

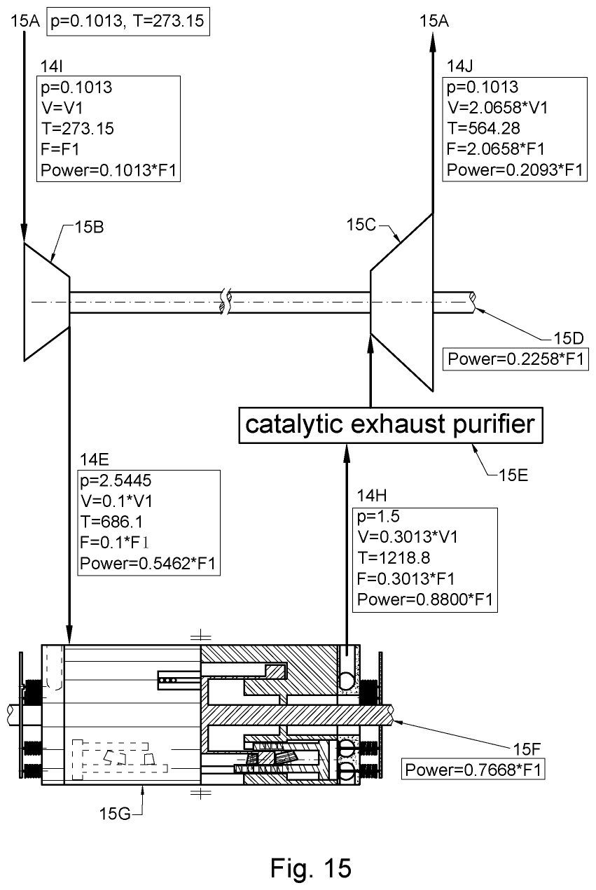

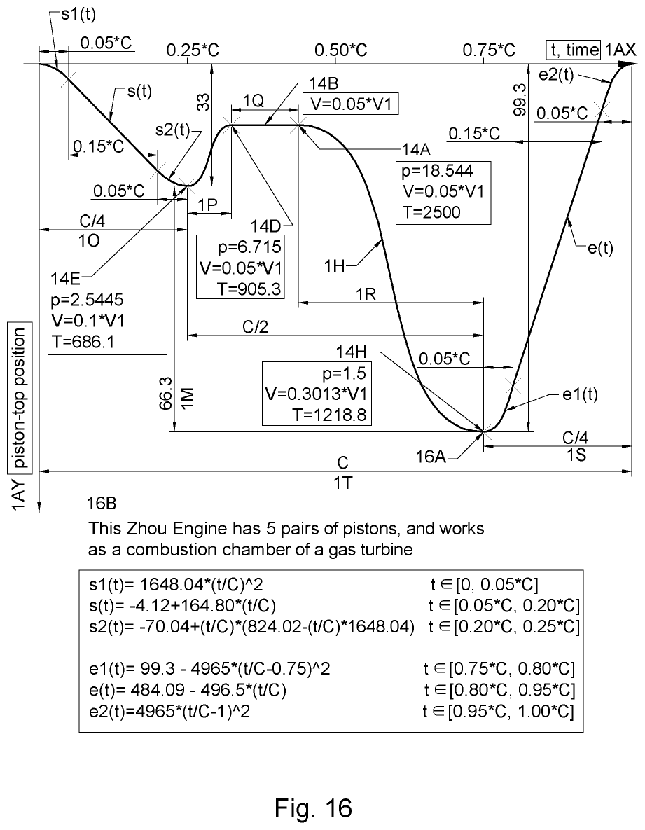

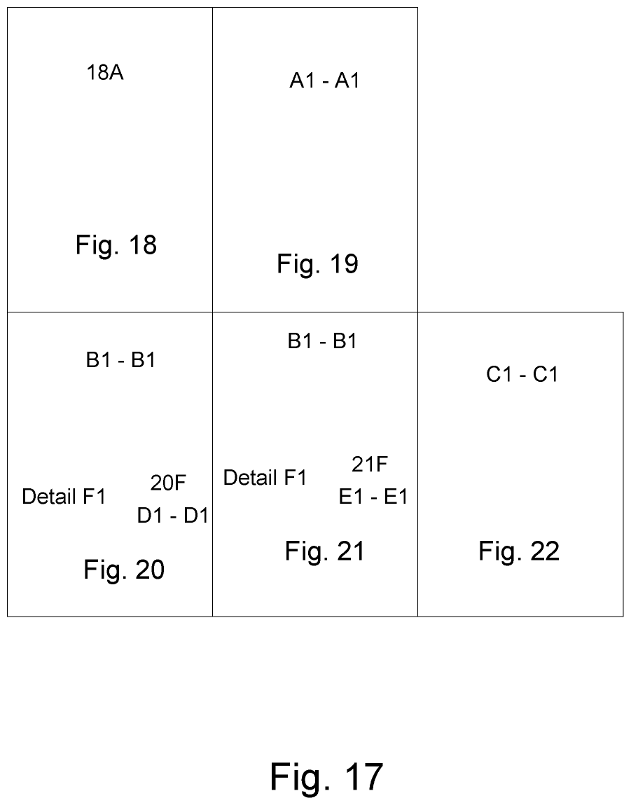

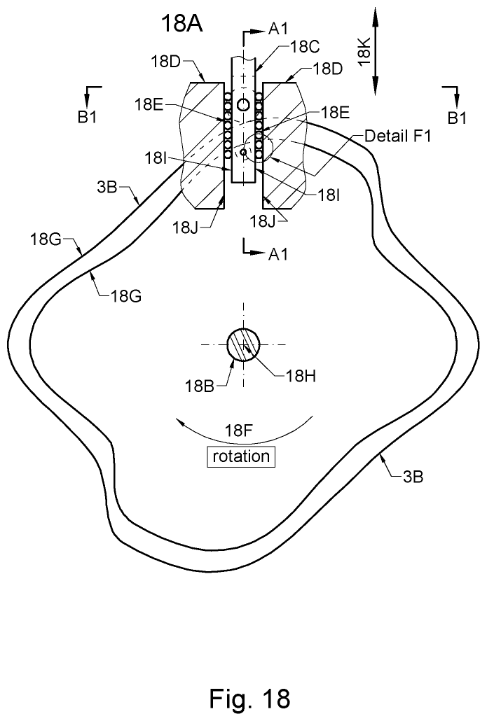

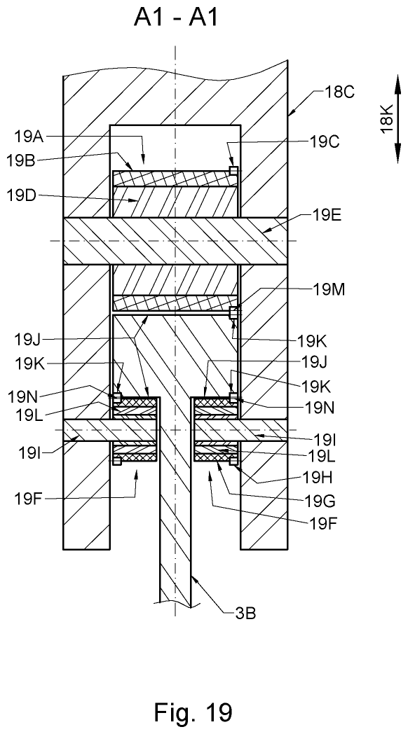

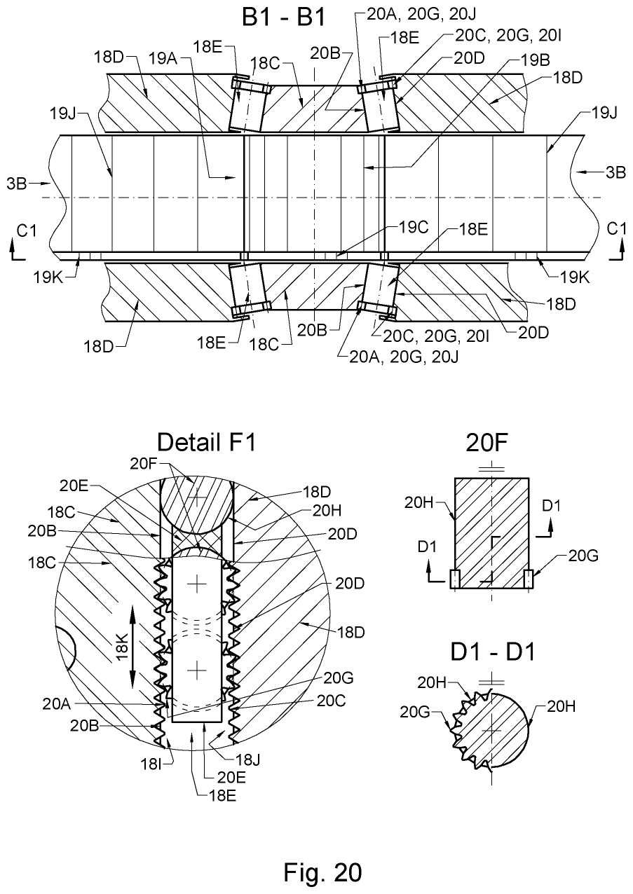

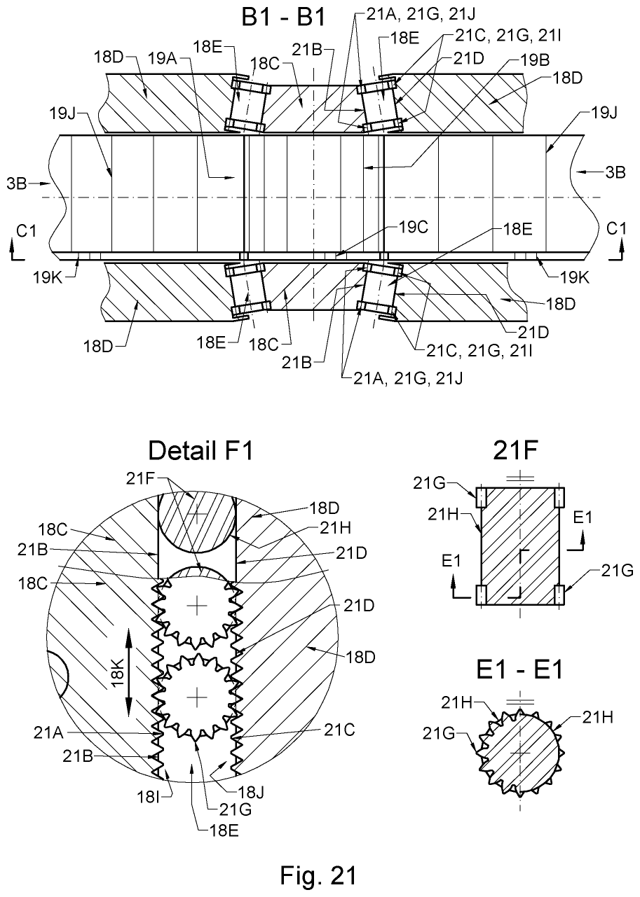

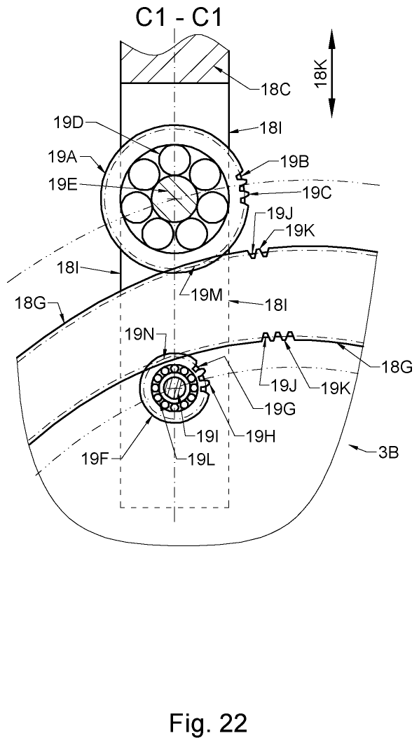

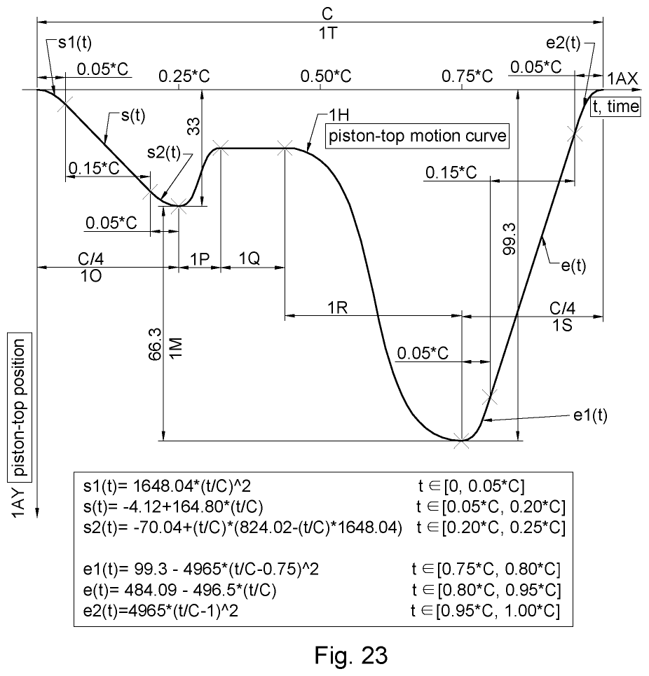

Compared with FIG. 2, which is the piston-top motion curve (1H) of a conventional four-stroke engine, FIG. 1 shows exclusive characteristics of Zhou Engine there: combustion period (1Q), extra expansion (1M), arbitrary duration in each process and various lengths of each stroke, adjustable piston-top motion curve (1H). To implement the Zhou Engine, the piston-top motion curve (1H) is designed first. It is possible to design the segments within the intake stroke (1O) and the exhaust stroke (1S) of this curve (1H) to obtain the best airflow. The Zhou Engine shortens the compression stroke (1P) duration, and reserves duration to optimize the combustion process. This engine also provides the expansion stroke (1R) more volume of produce more work and increase thermal efficiency. Further optimization can be done by adjusting this curve (1H). To achieve this motion for the piston, the Zhou Engine utilizes a power-cam mechanism, toothed-rollers and toothed-tracks, reference FIG. 3 and FIG. 9.

FIG. 2: The piston-top motion curve (1H) of a conventional four-stroke engine. The meanings of symbols in FIG. 2 are the same as in FIG. 1, and see table 1 above. This curve is similar to cosine curve and defined by a crank-link mechanism. FIG. 2 is only for comparison with FIG. 1.

FIG. 3: General Assembly of Example A of Zhou Engine. The parts of Example A are shown in FIG. 4 to 8.

TABLE 3

| Parts | Quantity | Reference |
|---|---|---|
| Power-cam (3B) | 1 | FIG. 4 |
| Shell (3C) | 2 | FIG. 5 |
| Cylinder (3D) | 10 | FIG. 7 |
| Piston (3E) | 10 | FIG. 6 |
| Toothed-roller array (3F) | 40 | FIG. 8 |

The parts list in table 3 above. The meanings of the symbols in this drawing are in the following table (table 11

TABLE 3.1

| Symbols | Meanings |
|---|---|
| 3A | General Assembly of Example A of Zhou Engine |
| 3B | power-cam |
| 3C | shell |
| 3D | cylinder |
| 3E | piston |
| 3F | toothed-roller array |
| 3G | Main Shaft, of the power-cam (3B), for power output |
| 3H | Joint bolt, to joint two shells (3C) together. |
| 3I | Toothed-roller, of the toothed-roller array (3F) |
| 3J | bearing surface, of the toothed-track (3Q) of the piston (3E) |
| 3K | Teeth, of the toothed-track(3Q) of the piston (3E) |
| 3L | Cage, of the toothed-roller array (3F) |
| 3M | bearing surface, of the toothed-track (3R) of the shell (3C) |
| 3N | teeth, of the toothed-track (3R)of the shell (3C). |
| 3O | The hole is opened here. The holes are usually covered. |
| 3P | Reciprocating motion, of the piston (3E) |
| 3Q | Toothed-track, of the piston (3E) |
| 3R | Toothed-track, of the shell (3C) |
| 3S | A set of cylinder head and valve timing mechanism and |
| | fuel supply system and ignition system is essential |
| | and not shown here |

This Zhou Engine comprises: 1 power-cam (3B), 2 shells (3C), 5 pairs of cylinders (3D), 5 pairs of pistons (3E), 40 toothed-roller arrays (3F), 1 set of cylinder head and valve timing mechanism and fuel supply system and ignition system (3S). It has 3 obviously characteristics as follows:

(a) The pistons (3E) work as pairs, at the same axial line, and in precise inverse motion.

(b) The one power-cam (3B) drives the all pistons (3E) by the tracks of the power-cam and the wheels mounted on the pistons (3E), and vice versa.

(c) The pistons (3E) are in reciprocating motion, and are confined by the cylinders (3D) and the toothed-roller arrays (3F).

A set of cylinder heads, valve timing mechanism, fuel supply system and ignition system, is essential, but is not shown in this drawing, and can be designed conventionally. That is similar to some radial engine. The difference is in the cams which drive the valves and fuel pumps. The cams can be direct fixed on the main shaft (3G) in this Zhou Engine. The intake valves open in the intake stroke, and close at all other times. The exhaust valves open in the exhaust stroke, and close at all other times. The fuel injection starts at the beginning of the combustion period (1Q), then spark ignite if needed. The intake valves, the exhaust valves, the fuel injections and the spark ignitions work the same as in a conventional four-stroke engine.

A Zhou Engine can be designed with any number of cylinders (3D).

FIG. 4: The power-cam (3B) of Example A. The meanings of the symbols are in the following table (table 4).

TABLE 4

| Symbols | Meanings |
|---|---|
| 1O | intake stroke |
| 1P | compression stroke |
| 1Q | combusion period |
| 1R | expansion stroke |
| 1S | exhaust stroke |
| 3B | Power-cam |
| 3E | Piston |
| 3G | Main shaft, for power output |
| 4A | 1 work cycle = 180°, |
| | that takes 1 cycle time |
| 4B | rotation direction |
| 4C | track |
| 4D | Piston (3E) reciprocating motion |

The curvature of the tracks (4C) of the power-cam (3B) is designed according to the piston-top motion curve (1H, in FIG. 1) of Zhou Engine. While the power-cam (3B) is rotating, the piston (3E) will be in reciprocating motion (4D) following the piston-top motion curve (1H, in FIG. 1), and keep repeating. This power-cam (3B) has two work cycles each round, and corresponding to the pistons (3E) are set in pairs, to remove this engine vibrating.

The vibration of this Zhou Engine can be removed by specifying the number of work cycles of the power-cam each round to be greater than one. But, if the number is greater than two, the solid mechanical parameters of this Zhou Engine will worsen.

Example A needs one power-cam (3B).

FIG. 5: The shell (3C) of Example A. The meanings of the symbols are in the following table (table 5).

TABLE 5

| Symbols | Meanings |
|---|---|
| 3C | shell |
| 3M | bearing surface, of the toothed-track (3R), |
| | for the toothed-rollers (3I) rolling on |
| 3N | Teeth, in a row, of the toothed-track (3R), |
| | for the toothed-rollers (3I) meshing |
| 3R | toothed-track |
| 5B | shaft hole |
| 5C | Through-hole, to attach another shell together |
| 5D | Hole, to install the small wheels of the pistons, |
| | showing in FIG. 3 is 3O |
| 5E | cylinders inlay here |

This shell has 20 toothed-tracks (3R), 1 shaft hole (5B), 10 through-holes (5C), 10 holes (5D). Each toothed-track (3R) has 1 bearing surface (3M), and many teeth (3N) in a row.

Example A needs two shells (3C).

FIG. 6: The piston (3E) of Example A. The meanings of the symbols are in the following table (table 6).

TABLE 6

| Symbols | Meanings |
|---|---|
| 3E | Piston |
| 3J | bearing surface, of the toothed-track (3Q), |
| | for the toothed-rollers (3I) rolling on |
| 3K | Teeth, in a row, of the toothed-track (3Q), |
| | for the toothed-rollers (3I) meshing |
| 3Q | toothed-track, the same as 3R, reference the |
| | Detail F of FIG. 5 |
| 6A | Big wheel |
| 6B | Small wheel |
| 6C | bearing surface of the wheel |
| 6E | roller bearings |

This piston (3E) comprises: 1 big wheel (6A), 2 small wheels (6B), and 4 toothed-tracks (3Q). Each toothed-track has many teeth (3K) in a row, and 1 bearing surface (3J).

Example A needs 5 pairs of pistons (3E).

FIG. 7: The cylinder (3D) of Example A. The meanings of the symbols are in table 7.

TABLE 7

| Symbols | Meanings |
|---|---|
| 3D | Cylinder |
| 7A | this end inlay shells (3C) |

Example A needs 5 pairs of cylinders (3D).

FIG. 8: The toothed-roller array (3F) of Example A and toothed-roller (3I) of Example A. The meanings of the symbols are in the following table (table 8).

TABLE 8

| Symbols | Meanings |
|---|---|
| 3F | Toothed-roller array |
| 3I | Toothed-roller |
| 3L | cage, that restricts and synchronizes the |
| | many toothed-rollers (3I) |
| 8A | bearing surface, of the toothed-roller (3I) |
| 8B | Teeth, of the toothed roller (3I) |

A toothed-roller array (3F) is that a cage (3L) restricts and synchronizes many toothed-rollers (3I). A toothed-roller has 1 bearing surface (8A) and many teeth (8B). Or rather, a toothed-roller (3I) is a roller, but with teeth (8B). While they are working, the synchronized toothed-rollers (3I) roll between the toothed-track of the shell (3R) and the toothed-track of the piston (3Q), and mesh their teeth (8B, 3K, 3N).

Example A needs 40 toothed-roller arrays.

FIG. 9: The General Assembly of Example B of Zhou Engine. The meanings of the symbols in this drawing are in table 9 below. The main parts of Example B are shown in FIG. 10 to 13, and listed in table 9.1 below.

TABLE 9

| Symbols | Meanings |
|---|---|
| 9A | General Assembly of Example B of Zhou |
| | Engine |
| 9B | shell |
| 9C | Power-cam |
| 9D | piston |
| 9E | Toothed-roller array A |
| 9F | Toothed-roller array B |
| 9G | main shaft, of the power-cam (9C) |
| 9H | Big wheel, of the piston (9D) |
| 9I | bearing surface here and rolling here |
| 9J | meshing here |
| 9K | Sections of the piston (9D) |
| 9L | cylinder, of the shell (9B) |
| 9M | Joint bolt, to joint two shells and two |
| | cylinder heads together. |
| 9N | Cam, for driving valves, fixed on the |
| | main shaft (9G) directly |
| 9O | Intake valve |
| 9P | Exhaust valve |
| 9Q | Cylinder head |
| 9R | Air |
| 9S | Exhaust gas |
| 9T | Spring |
| 9U | Toothed-track, of the shell (9B) |
| 9V | Toothed-track, of the piston (9D) |
| 9W | fuel supply system and ignition system, |
| | are necessary and not shown here |

TABLE 9.1

| Parts | Quantity | Reference |
|---|---|---|
| Shell (9B) | 2 | FIG. 10 |
| Power-cam (9C) | 1 | FIG. 11 |
| Piston (9D) | 6 | FIG. 12 |
| Toothed-roller array A (9E) | 12 | FIG. 13 |
| Toothed-roller array B (9F) | 12 | FIG. 13 |

This Zhou Engine comprises: 3 pairs pistons (9D), 2 shells (9B), 1 power-cam (9C), 12 toothed-roller array A's (9E), 12 toothed-roller B's (9F). The number of cylinders (9L) equals that of pistons (9D). This engine has 3 characteristics as follow:

(a) The pistons (9D) work as pairs, at the same axial line, and precisely inverse motion.

(b) The one power-cam (9C) drives all the pistons (9D), and vice versa, by the tracks of the power-cam and the wheels mounted on the pistons.

(c) Each piston (9D) is in reciprocating motion, and is confined by the cylinder (9L) and toothed-roller arrays (9E, 9F).

The cylinder heads (9Q), valves (9O, 9P) actuating mechanism, fuel supply system, and ignition system, can be designed conventionally. The intake valves (9O) open in the intake stroke (1O), close in all other times, and are driven by the cams (9N). The exhaust valves (9P) open in the exhaust stroke (1S), close in all other times, and are driven by the cams (9N). The fuel injection starts at the beginning of the combustion period (1Q), then spark ignite if it's needed. The intake valve (9O), the exhaust valve (9P), the fuel injection and the spark ignition work the same as in a conventional four-stroke engine. The cams (9N) direct fixed on the main shaft (9G) of the power-cam (9C), and are synchronous rotation with the power-cam (9C).

Zhou Engine can have any number of pistons (or cylinders).

FIG. 10: The Shell (9B) of Example B. The meanings of the symbols in this drawing are in table 10 below.

This shell (9B) comprises: 3 cylinders (9L), 12 toothed-tracks (9U), 6 through holes (10C), and 3 holes (10D). Each toothed-track has 1 bearing surface (10B), and many teeth (10E) in a row.

Example B needs two shells (9B).

TABLE 10

| Symbols | Meanings |
|---|---|
| 9B | Shell |
| 9L | Cylinder |
| 9U | toothed-track, toothed-rollers (13A, in FIG. 13) rolling here |
| 10A | main shaft hole |
| 10B | bearing surface, of the toothed-track (9U), |
| | for toothed-rollers (13A) rolling on |
| 10C | through hole, to attach with another shell |
| | and cylinder heads together |
| 10D | hole, for easy to install the small wheel of the piston (9D) |
| 10E | teeth, of the toothed-track (9U), |
| | for meshing toothed-rollers (13A) |

FIG. 11: The power-cam (9C) of Example B. The meanings of the symbols in this drawing are in the following table (table 11).

TABLE 11

| Symbols | Meanings |
|---|---|
| 1O | intake stroke |
| 1P | compression stroke |
| 1Q | combusion period |
| 1R | expansion stroke |
| 1S | exhaust stroke |
| 9C | Power-cam |
| 9D | Piston |
| 9G | main shaft |
| 11A | Rotation direction |
| 11B | track |
| 11C | Cylinder U |
| 11D | Expanded View |
| 11E | Piston (9D) reciprocating |
| | motion |

The curvature of the tracks (11B) of the power-cam (9C) is designed according to the piston-top motion curve (1H, in FIG. 1). While the power-cam (9C) is rotating, the piston (9D) will be in reciprocating motion (11E) following the piston-top motion curve (1H, in FIG. 1), and keep repeating. The tracks (11B) are for the wheels of the piston (9D) rolling along. The tracks are symmetrical, for corresponding to the piston pairs, to remove this engine vibrating.

Example B needs one power-cam (9C).

FIG. 12: The piston (9D) of Example B. The meanings of the symbols in this drawing are in table 12.

TABLE 12

| Symbols | Meanings |
|---|---|
| 9D | Piston |
| 9H | Big wheel |
| 9V | Toothed-track |
| 12A | Small wheel |
| 12B | Bearings, of the wheels, conical roller bearing |
| 12C | bearing surface, of the toothed-track (9V) |
| 12D | Teeth, in a row, of the toothed-track (9V) |
| 12E | bearing surface, of the big wheel (9H) |
| 12F | bearing surface, of the small wheel (12A) |

This piston (9D) has one big wheel (9H), one small wheel (12A), and four toothed-tracks (9V). Each wheel (9H or 12A) has bearings (12B). The bearing (12B) is conical roller bearing. Each toothed-track (9V) has one bearing surface (12C) and many teeth (12D) arranged in a row, for the toothed-roller array (9E or 9F) rolling along.

Example B needs 3 pairs of pistons (9D).

FIG. 13: Toothed-roller array A (9E), toothed-roller array B (9F) and toothed-roller (13A) of Example B. The meanings of the symbols in this drawing are in the following table (table 13).

TABLE 13

| Symbols | Meanings |
|---|---|
| 9E | Toothed-roller array A |
| 9F | Toothed-roller array B |
| 13A | Toothed-roller |
| 13B | Cage A, of the Toothed-roller array |
| | A (9E) |
| 13C | Cage B, of the Toothed-roller array |
| | B (9F) |
| 13D | teeth, of the toothed-roller (13A) |
| 13E | bearing surface, of the toothed-roller (13A) |

Each toothed-roller array A (9E) comprises one cage A (13B) and many toothed-rollers (13A). Each toothed-roller array B (9F) comprises one cage B (13C) and many toothed-rollers (13A). Each the toothed-roller (13A) has 1 bearing surface (13E) and many teeth (13D).

Example B needs 12 toothed-roller array As (9E) and 12 toothed-roller array Bs (9F).

FIG. 14: Example C, in FIGS. 14 to 16, is an appliance of a Zhou Engine working together with a multistage dynamic compressor and a turbine. Or rather, Example C shows a Zhou Engine works as a combustion chamber of a gas turbine, and also produces extra work.

TABLE 14
The meanings of symbols in mathematical expressions

| Symbols | Meanings | Initial values |
|---|---|---|
| p | Pressure, unit is MPa | 0.1013 MPa, intake air |
| T | Temperature, unit is K | 273.15 K, intake air |
| V | working substance volume in one work | V1, intake in one work cycle |
| | cycle, unit is stere | |
| F | volume flow rate, unit is stere/s | F1, the volume flow rate of intake |
| Power | mechanical power, unit is MW | |
| t | time | |
| C | Cycle time | |

| | |
|---|---|
| A | cross-sectional area of a pair of cylinders |
| F(t) | Function, to describe the whole volume flow rate of this Zhou Engine (15G) in either |
| | intake pipe or exhaust pipe |
| s1(t), s(t), s2(t) | Functions, that describe the position of the piston-top in intake stroke |
| e1(t), e(t), e2(t) | Functions, that describe the position of the piston-top in exhaust stroke |

FIG. 14 shows the pV-diagram of Example C, and fits Zhou Engine.

TABLE 14.1
The meanings of symbols in drawings of FIG. 14 to 16

| Symbols | Meanings |
|---|---|
| 1AX | Time, use “t” to represent in expressions |
| 1AY | Piston-top position, that is distance between piston-top and cylinder head |
| 1H | piston-top motion curve |
| 1M | extra expansion |
| 1O | intake stroke |
| 1P | compression stroke |
| 1Q | combusion period |
| 1R | expansion stroke |
| 1S | exhaust stroke |
| 1T | Work cycle, use “C” to represent cycle time in expressions |
| 14A | A point, on the curve |
| 14AX | V, volume, ×V1, which unit is stere |
| 14AY | p, pressure, which unit is MPa |
| 14B | constant volume combustion in combustion period, from 14D to 14A |
| 14C | Adiabatic expansion, from 14A to 14J, equivalent of expansion stroke |
| 14D | A point, on the curve |
| 14E | A point, on the curve |
| 14F | A point, on the curve |
| 14G | Adiabatic compression, from 14I to 14D, equivalent of compression stroke |
| 14H | A point, on the curve |
| 14I | A point, on the curve, equivalent of in intake stroke |
| 14J | A point, on the curve, equivalent of in exhaust stroke |
| 15A | Atmosphere |
| 15B | multistage dynamic compressor, adiabatic compressing here in this example |
| 15C | Turbine |
| 15D | Power output from the turbine (15C) |
| 15E | catalytic exhaust purifier |
| 15F | Power output from the Zhou Engine (15G) |
| 15G | Zhou Engine, its charateristic parameters are in FIG. 16 |
| 16A | This is the maximum work volume in whole work cycle |
| 16B | This Zhou Engine has 5 pairs of pistons, and works as a combustion chamber of gas turbine |

The meanings of symbols in following mathematical expressions are in table 14 above.

Basic assumption: Working substance is air, is the ideal gas, and its adiabatic index is 1.4; The initial values of p, T, V, F are shown in table 14 above; The compression ratio of this engine is 20; The maximum temperature of combustion is limited in 2500 K.

Of course, F is proportional to V.

Based on the above, this pV-diagram (pressure-volume diagram) is drawn in FIG. 14. This pV-diagram is a scale drawing.

Meanings of symbols in drawings of FIGS. 14 to 16 are in table 14.1 above.

The intake stroke is at 14I, and the exhaust stroke is at 14J, they are not drawn.

In this pV-diagram, its absorption heat in combustion period (14B) is 1.4796*V1 (MJ), it produces total work 1.1006*V1 (MJ), and its thermal efficiency is 74%. This pV-diagram also shows—its compression ratio is the same as Diesel engine, its combustion process is the same as Otto engine, and its expansion stroke is some likeness to a turbine which has full expansion.

Those points, 14E, 14F, 14H, are the joint points of Zhou Engine with multistage dynamic compressor and turbine.

FIG. 15: Example C, which is a Zhou Engine (15G) works together with a multistage dynamic compressor (15B) and a turbine (15C).

Meanings of symbols in mathematical expressions are in table 14 above.

Meanings of symbols in this drawing are in table 14.1 above.

In this drawing, the appliance has two output shafts, one shaft on Zhou Engine (15F), and one shaft on turbine (15D). Or rather, the Zhou Engine (15G) works as a combustion chamber of gas turbine but has large extra power output. The gas flow behavior of the Zhou Engine is the key, which shows in FIG. 16. To reduce pollution, a catalytic exhaust purifier (15E) is placed between the Zhou Engine (15G) and turbine (15C), to meet the working temperature requirement of the purifier (15E).

FIG. 16: The piston-top motion curve (1H) of the Zhou Engine (15G) of Example C.

Meanings of symbols in mathematical expressions are in table 14 above.

The meanings of symbols in this drawing are in table 14.1 above.

This Zhou Engine (15G) has 5 pairs of pistons, and each of their intake strokes and exhaust strokes takes a quarter of cycle time (C/4). This means that intake stroke of each pair partial overlaps other pairs, and so does the exhaust stroke. Then we reason as the following:

(a) The curve within intake stroke is divided into 3 segments—s1(t), s(t), s2(t)—and each of them occupies different time interval. Then, the functions of these 3 segments are created in expression (1):

$$\begin{matrix}s 1 ( t ) = 164 \; 8.0 {4}^{*} {( t / C )}^{2} & t ∈ [ 0 , 0.0 {5}^{*} C ] \\ s ( t ) = - 4.12 + 164.8 {0}^{*} ( t / C ) & t ∈ [ 0.0 {5}^{*} C , 0.2 {0}^{*} C ] \\ s 2 ( t ) = - 70.04 + {( t / C )}^{*} ( 824.02 - {( t / C )}^{*} 1648.04 ) & t ∈ [ 0.2 {0}^{*} C , 0.2 {5}^{*} C ]\end{matrix} \} . \qquad ( 1 )$$

While this piston-pair is working on sl(t) and t∈[0, 0.05*C], the previous piston-pair is working on s2(t). Their works overlap and their phase difference is 0.2*C. So the intake air volume flow rate F(t):

$$\frac{F ( t ) = \dot{s 1} {( t )}^{*} A + \dot{s 2} {( t = t + 0 . {2}^{*} C )}^{*} A = 164.80 / {C}^{*} A}{previous piston pair} \qquad t ∈ [ 0 , 0.0 {5}^{*} C ] . \qquad ( 2 )$$

While this piston-pair is working on s(t) and t∈[0.05*C, 0.2*C], it works alone, the intake air volume flow rate F(t):

$$F ( t ) = \dot{s} {( t )}^{*} A = 164.80 l {C}^{*} A \qquad t ∈ [ 0.0 {5}^{*} C , 0.2 {0}^{*} C ] . \qquad ( 3 )$$

While this piston-pair is working on s2(t) and t∈[0.2*C, 0.25*C], the next piston-pair is working on sl(t), their works overlap and their phase difference is 0.2*C. Or rather, the F(t) repeats the expression (2) on the next piston-pair, then we turn our viewpoint on next piston-pair as the power-cam rotates, and repeat reasoning expression (2) and expression (3) . . . .

Thus, the processes of expression (2) and expression (3) keep alternating and repeating as the power-cam rotating.

Therefore, F(t) equals 164.80/C*A at any time, which is a constant. So, the volume flow rate F(t) of intake of this Zhou Engine (15G), is very steady, has no pulsation, and can perfectly match the multistage dynamic compressor. This intake flow is much different from that in a conventional four-stroke engine.

We can deduce the following conclusions: any piston motion on expression (1), its position is continual, its speed is continual, and the absolute value of its acceleration is minimal. The deducing processes omit here.

(b) Following above analytical process, the curve within exhaust stroke, is divided into 3 segments—e1(t), e(t), e2(t)—and each of them takes different time interval. Then, the functions of these 3 segments are created in expression (4).

$$\begin{matrix}e 1 ( t ) = 99.3 - {4965}^{*} {( t / C - 0.75 )}^{2} & t ∈ [ {0.75}^{*} C , {0.80}^{*} C ] \\ e ( t ) = 484.09 - {496.5}^{*} ( t / C ) & t ∈ [ {0.80}^{*} C , {0.95}^{*} C ] \\ e 2 ( t ) = {4965}^{*} {( t / C - 1 )}^{2} & t ∈ [ {0.95}^{*} C , {1.0}^{*} C ]\end{matrix} \} . \qquad ( 4 )$$

Following item (a) above, we can deduce that—the whole exhaust volume flow rate F(t) of this engine (15G) is very steady and has no pulsation. The deducing process omits here.

We can deduce the following conclusions: any piston motion on expression (4), its position is continual, its speed is continual, and the absolute value of its acceleration is minimal. The deducing processes omit here.

Therefore, the exhaust gas flow from this Zhou Engine (15G) fits to drive a turbine, and is much different with that from a conventional four-stroke engine.

According to item (a) and item (b), Zhou Engine could be a good combustion chamber of a gas turbine; more than that, it has an extra power output (15F), even greater than the original power output.

Note, the s1(t), s(t), s2(t), e1(t), e(t) and e2(t), are all exact functions.

(c) It needs just a small working volume (14E) V=0.1*V1 (conventionally V=V1) in this Zhou Engine for intake air from the compressor (15B, in FIG. 15). Thus, we can reduce the total engine volume.

(d) Paying attention to the 14H in FIGS. 15 and 16, this Zhou Engine (15G) reserve much Power in its exhaust to drive the turbine (15C). First, the Power will be used up by the turbine, no waste. Second, this will reduce the working volume of this Zhou Engine to V=0.3013*V1 (at 14H, conventionally V=V1), which is the maximum working volume required in the whole work cycle. So, the volume of this Zhou Engine can be reduced to about the 0.3013 times of its original.

To select the parameters of 14H, we must consider the catalysis exhaust purifying (15E, in FIG. 15), high temperature resistance of the turbine (15C), power matching, and something else. If we use the parameters of 14F (p=2.863, V=0.1899*V1, T=1466, in FIG. 14) to instead of that of 14H, the engine volume becomes smaller further, but the turbine (15C) must bear the high temperature of 1466 K. Comparing the parameters of 14H and 14F with the entrance parameters of the turbine of the Textron Lycoming AGT 1500 turbo shaft (reference in internet), the formers are obviously better.

Conventionally, to increase thermal efficiency of gas turbine, we can increase the compression ratio and/or increase hot gas temperature. However the hot gas temperature is the difficult part. Now, we can use the Zhou Engine as its combustion chamber, and properly select the temperature of exhaust to fit the gas turbine. Since there are temperature limits in a cylinder and in a turbine, the temperature limit in a cylinder is much higher than that in a turbine. So, we use the cylinders of this Zhou Engine (15G) to withstand the higher temperature, to increase total appliance thermal efficiency.

(e) The smaller working volume is needed in this Zhou Engine as showing in item (c) and (d). That means—not only the volume of the engine gets much smaller, but also the rated speed can be much increase accordingly. This further enhances the power density of the whole appliance.

(f) It is only for easy analysis in this example that constant volume combustion at the 14B in FIGS. 14 and 16. There are several combustion state could be chosen in Zhou Engine, which include constant volume combustion, isothermal combustion, isobaric combustion, or the former 3 combustions combination. If we keep the combustion process on a sustainable high pressure boundary or on a sustainable high temperature boundary, we should get high thermal efficiency. We can keep the combustion process on those boundaries in Zhou Engine as great as possible.

(g) It is only for easy analysis in this example, that adiabatic compression, in the multistage dynamic compressor (15B) in FIG. 15, and at the 14G in FIG. 14. Conventionally, if we properly choose interstage cooling in the multistage dynamic compressor (15B), we will get higher thermal efficiency.

FIG. 17: Power-cam mechanism general drawing, which includes 5 drawings, FIGS. 18 to 22. The meanings of all symbols in these drawings are in table 18 below.

FIG. 18: Power-cam mechanism (18A). The meanings of symbols in this drawing are in table 18 below.

This power-cam mechanism (18A) comprises: 1 power-cam (3B), 1 follower (18C), 1 casing (18D), and 4 toothed-roller arrays (18E). The power-cam (3B) has 3 tracks (18G), 1 shaft (18B). The follower (18C) has 3 wheels (19A, 19F), 4 toothed-tracks (18I). The casing (18D) is stationary and has 4 toothed-tracks (18J). Each toothed-roller array (18E) has many toothed-rollers (20F, 21F) which are restricted and synchronized.

There are 2 examples of toothed-roller arrays and the corresponding toothed-tracks. They are in FIG. 20 and in FIG. 21 respectively. And they had better be alternatively used.

TABLE 18
Meanings of symbols in drawings of FIG. 18 to 22

| Symbols | Meanings |
|---|---|
| 3B | Power-cam |
| 18A | Power-cam mechanism |
| 18B | Shaft, rigidly fixed on the power-cam (3B) |
| 18C | Follower |
| 18D | Casing, stationary |
| 18E | Toothed-roller array, that is many toothed-rollers |
| | (20F, 21F) are restricted and synchronized |
| 18F | Power-cam rotation round the axle center (18H) |
| 18G | Track, of the power-cam (3B) |
| 18H | Axle center, stationary |
| 18I | Toothed-track, of the follower (18C) |
| 18J | Toothed-track, of the casing (18D) |
| 18K | Follower (18C) motion |
| 19A | Wheel A, of the follower (18C) |
| 19B | Bearing surface, of the wheel A (19A) |
| 19C | Teeth, of the wheel A (19A) |
| 19D | Roller bearing, of the wheel A (19A) |
| 19E | Axle A, of the follower (18C) |
| 19F | Wheel B, of the follower (18C) |
| 19G | Bearing surface, of the wheel B (19F) |
| 19H | Teeth, of the wheel B (19F) |
| 19I | Axle B, of the follower (18C) |
| 19J | Bearing surface, of the track of the power-cam (18G) |
| 19K | Teeth, of the track of the power-cam (18G) |
| 19L | Roller bearing, of the wheel B (19F) |
| 19M | Wheel A (19A) mesh power-cam (3B) here with their teeth |
| 19N | Wheel B (19F) mesh power-cam (3B) here with their teeth |
| 20A | Teeth, of the toothed-track of the follower (18I) |
| 20B | bearing surface, of the toothed-track of the follower (18I) |
| 20C | Teeth, of the toothed-track of the casing (18J) |
| 20D | bearing surface, of the toothed-track of the casing (18J) |
| 20E | Cage |
| 20F | Toothed-roller |
| 20G | Teeth, of the toothed-roller (20F) |
| 20H | Bearing surface, of the toothed-roller (20F) |
| 20I | Toothed-roller (20F) mesh the toothed-track of the casing |
| | (18J) here with their teeth |
| 20J | Toothed-roller (20F) mesh the toothed-track of the follower |
| | (18I) here with their teeth |
| 21A | Teeth, of the toothed-track of the follower (18I) |
| 21B | bearing surface, of the toothed-track of the follower (18I) |
| 21C | Teeth, of the toothed-track of the casing (18J) |
| 21D | bearing surface, of the toothed-track of the casing (18J) |
| 21F | Toothed-roller |
| 21G | Teeth, of the toothed-roller (21F) |
| 21H | Bearing surface, of the toothed-roller (21F) |
| 21I | Toothed-roller (21F) mesh the toothed-track of the casing |
| | (18J) here with their teeth |
| 21J | Toothed-roller (21F) mesh the toothed-track of the follower |
| | (18I) here with their teeth |

FIG. 19: A1-A1 cutaway view. The meanings of symbols in this drawing are in table 18 above.

FIG. 20: Showing the toothed-rollers with single circle teeth (20F) and the corresponding toothed-tracks, in B1-B1 cutaway view, Detail F1, 20F (cutaway view), D1-D1 cutaway view. This drawing and FIG. 21 had better be alternatively used. The meanings of symbols in this drawing are in table 18 above.

In this drawing, the toothed-roller array (18E) is that a cage (20E) restricts and synchronizes many toothed-rollers (20F). Each toothed-roller (20F) has 1 bearing surface (20H) and many teeth (20G) in a circle. Correspondingly, the toothed-track of the follower (18I) has 1 bearing surface (20B) and many teeth (20A) in a row; the toothed-track of the casing (18J) has 1 bearing surface (20D) and many teeth (20C) in a row. While they are working, the synchronized toothed-rollers (20F), roll between the toothed-track of the follower (18I) and the toothed-track of the casing (18J), withstand the normal force with their bearing surface (20H, 20B, 20D) contacting, and mesh (20I, 20J) their teeth (20G, 20A, 20C), to keep the toothed-rollers (20F) always in the proper position and from sliding.

FIG. 21: Showing the toothed-rollers with two circles of teeth (21F) and the corresponding toothed-tracks, in B1-B1 cutaway view, Detail F1, 21F (cutaway view), E1-E1 cutaway view. This drawing and FIG. 20 had better be alternatively used. The meanings of symbols in this drawing are in table 18 above.

In this drawing, the toothed-roller array (18E) is that many toothed-rollers (21F) are restricted and synchronized by the toothed-track of the follower (18I) and the toothed-track of the casing (18J). Each toothed-roller (21F) has 1 bearing surface (21H) and many teeth (21G) in two circles. Correspondingly, the toothed-track of the follower (18I) has 1 bearing surface (21B) and many teeth (21A) in 2 rows, and the toothed-track of the casing (18J) has 1 bearing surface (21D) and many teeth (21C) in 2 rows. While they are working, the synchronized toothed-rollers (21F), roll between the toothed-track of the follower (18I) and the toothed-track of the casing (18J), withstand the normal force with their bearing surface (21H, 21B, 21D) contacting, and mesh (21I, 21J) their teeth (21A, 21C, 21G), to keep the toothed-rollers (21F) always in the proper position and from sliding.

FIG. 22: C1-C1 cutaway view. The meanings of symbols in this drawing are in table 18 above.

This drawing and FIG. 19 show the wheels (19A, 19F) of the follower (18C), the tracks (18G) of the power-cam (3B). The wheel A (19A) of the follower (18C) has 1 bearing surface (19B) and many teeth (19C) in a circle, the wheel B (19F) of the follower (18C) has 1 bearing surface (19G) and many teeth (19H) in a circle. Correspondingly, each track (18G) of the power-cam (3B) has 1 bearing surface (19J) and many teeth (19K). While they are working, they withstand the normal force by their bearing surface (19B, 19G, 19J) contacting, and they mesh (19M, 19N) their teeth (19C, 19H, 19K) to prevent the wheels (19A, 19F) from sliding in speed changing. The wheels (19A, 19F) always change speed periodically.

FIG. 23: This drawing accompanies the abstract, and is a simplification of FIG. 16. The meanings of symbols are in table 14 and 14.1 above.

1. An engine comprising:
two shells, which comprising a plurality of cylinders and a plurality of toothed tracks,
a plurality of pistons, wherein each of the plurality of pistons is configured to move inside one of the plurality of cylinders; wherein each piston comprises toothed tracks and wheels;
a plurality of arrays of toothed rollers, each array of toothed rollers configured to roll between and mesh with one of the toothed tracks of one of the pistons and one of the toothed tracks of the shells;
a cam, named power-cam, comprising tracks, wherein the cam is configured to drive the pistons, via the wheels of the pistons and the tracks of the cam, and to force the piston's motion along the piston-top motion curve (1H);
a plurality of cylinder heads;
a valve timing mechanism;
a fuel supplying system and
an ignition system.

2. The engine as defined in claim 1, wherein:
The work cycle of the engine completes five separate working processes during one revolution or less of the cam, and one single thermodynamic cycle, wherein the five separate working processes comprise an intake stroke, a compression stroke, a combustion period, an expansion stroke, and an exhaust stroke.

3. The engine as defined in claim 1, in which the one shell further comprise: a shaft hole to mount and rotate the cam; and holes for installation.

4. The engine as defined in claim 1, wherein the cylinders are set in pairs and each pair of the cylinders are at the same axial line, such that the two pistons inside the cylinder pair are configured to perform precisely reverse motion to each other.

5. The engine as defined in claim 1, in which the toothed-rollers (13A, in FIG. 13) of each array of toothed rollers are restricted and synchronized.

6. The engine as defined in claim 2, in which the cam tracks are designed and manufactured according to a piston-top motion curve (1H), such that each working process has a different duration and/or each stroke has a different length, and the cam tracks can be optimized segment by segment.

7. The engine as defined in claim 1, in which the one cam drives all the pistons, and vice versa.

8. The engine of claim 1, wherein the engine is an internal-combustion engine.

9. A gas turbine comprising a combustion chamber, wherein the combustion chamber is an engine according to claim 1 (FIG. 15).

10. An improved cam mechanism, named power-cam mechanism, comprises:
a cam comprising tracks,
a follower comprising toothed tracks and wheels; wherein the wheels are configured to follow the tracks of the cam,
a casing comprising toothed tracks,
a plurality of arrays of toothed rollers, each array of toothed rollers configured to roll between and mesh one of the toothed tracks of the follower and one of the toothed tracks of the casing.

11. The power-cam mechanism as defined in claim 10, in which the toothed-rollers (20F in FIG. 20, 21F in FIG. 21) of each of the plurality of arrays of toothed rollers are restricted and synchronized.

12. The power-cam mechanism of claim 10, wherein the toothed-tracks (18I, 18J) each comprise a bearing surface and a plurality of teeth.

13. The power-cam mechanism of claim 10, wherein the toothed-rollers each comprise a bearing surface and a plurality of teeth.

14. The power-cam mechanism of claim 10, wherein the plurality of toothed rollers are configured to withstand a normal force by contacting their bearing surfaces with the bearing surface of the toothed track.

15. The power-cam mechanism of claim 10, wherein the wheels of the follower have teeth and the tracks of the cam have teeth accordingly.

16. The power-cam mechanism of claim 10, wherein the teeth of the toothed-tracks of the follower, the teeth of the toothed-rollers, the teeth of toothed-tracks of the casing, the teeth of the wheels of the follower, and the teeth of the tracks of the cam, are of involute profile.
